(19) United States
(12) Patent Application Publication
(10) Pub. No.: US 2005/0215273 A1
(43) Pub. Date: Sep. 29, 2005

(54) Push-to-talk over cellular system

(75) Inventor: Naoko Ito, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 11/058,901

(22) Filed: Feb. 16, 2005

(30) Foreign Application Priority Data
Feb. 17, 2004 (JP) 2004-039939

(51) Int. Cl. H04Q 7/20

(52) U.S. Cl. 455/518; 455/517

(57) ABSTRACT

The present invention provides a PoC system which has the following capabilities: 1) it enables communication content to be confirmed afterwards; 2) by recording communication content in conjunction with information such as a caller identifier, it makes it easy to retrieve communication content afterwards; 3) it can record communication content only when this is necessary; 4) it can change as desired the criterion for deciding whether or not to record communication content; 5) it can record even during communications that include off-record content. Accordingly, when PoC group communication is taking place, the exchanged communication content is recorded during each session. Recording is only carried out when it is decided that recording is necessary. It is also possible to change whether communication content is recorded or not on a per-utterance basis. Communication content is indexed by session identifier and caller identifier, and a particular communication content can be fetched by specifying session and/or caller.

### BACKGROUND OF THE INVENTION

1. Field of the Invention

The present invention relates to Push-to-talk over Cellular (PoC), especially to recording of communication content in PoC.

2. Description of Related Art

PoC is a technique for utilizing mobile phones as transceivers, and makes 1-to-N communication possible. A PoC service is currently offered by for example Nextel Communications, Inc. of the USA.

Although there are several ways of implementing PoC, in each case the fundamental setup is the same and comprises a PoC server having session management and floor control functions, and a group and list management server (GLMS) for managing groups and lists. Background arts of this application are listed as follows;
Non-patent Reference 1: “Push-to-talk over Cellular; Architecture; PoC Release 1.0”, published online by Ericsson, Motorola, Siemens and Nokia (retrieved 29 Jan. 2004).
Internet URL: http://wwwericsson.com/multiservicenetworks/distr/PoC_specifications.zip
Patent Reference 1: Japanese Patent Application Publication No. 2002-091883
Patent Reference 2: Japanese Patent Application Publication No. 2002-116766
Patent Reference 3: Japanese Patent Application Publication No. 2003-016288.

The present description uses terminology in conformity with non-patent Reference 1. Note that the PoC client in the present description corresponds to the user equipment (UE) in non-patent Reference 1.

Because PoC is a service offering real-time communication, when communication is to be carried out within a group, a user who cannot join the PoC communication at that point in time, for example, an out-of-range user, will be unable to join the communication. Further, because there is no means for recording communication content, there is no means whereby a user who was unable to join a session or a part of a session can acquire and thereby confirm communication content corresponding to that portion of a session which the user did not join, or whereby a user who has joined a group communication can afterwards confirm the communication content.

Although there are some PoC services, such as the Instant Talk service offered by Ericsson, which provide means for leaving messages for non-participating users, there is no method for conveying the communication content itself.

Moreover, although Patent References 1, 2 and 3 disclose the recording of data acquired from content provided by a contents service provider, and the transfer of this recorded data to others, this is still not equivalent to recording the communication content itself.

### SUMMARY OF THE INVENTION

The present invention has been devised to eradicate such shortcomings. It is therefore an object of this invention to provide a PoC system which has the following capabilities: 1) it enables communication content to be confirmed afterwards; 2) by recording communication content in conjunction with information such as a caller identifier (where “caller” signifies a user who makes a call), it makes it easy to retrieve communication content afterwards; 3) it can record communication content only when this is necessary; 4) it can change as desired the criterion for deciding whether or not to record communication content; 5) rather than simply logging, it can determine, for each speech episode, whether recording is necessary or not, and can therefore perform recording even during communications that include off-record content which it is not desired to leave on record.

To attain these objects, according to the present invention, when PoC group communication is taking place, the communication content exchanged during each session is recorded during the session. Recording is carried out only when it is decided that recording is necessary. Also, whether communication content is recorded or not can be changed on a per-utterance basis. Communication content is indexed by session identifier and caller identifier, and a particular communication content can be fetched by specifying session and/or caller.

If it is necessary to record communication content during group communication, the PoC server of the present invention can record received communication content together with floor control commands and information such as session identifiers, caller identifiers and time series information, such information items being acquired from the communication data. The content recorded by a recording module can be looked up by an arbitrary means. The recording module can be implemented on at least one client that joins the PoC session.

According to a first aspect, it is provided a PoC system comprising a PoC server and PoC clients in which said PoC server gives a push-to-talk over cellular service to said PoC clients for making 1-to-N communication, which comprises a recording means for recording communication content.2.

The PoC system may preferably further comprises a deciding means for deciding whether recording of communication content is necessary or not. It is thereby possible to selectively record communications that satisfy prescribed conditions, rather than record all communications.

Both of the recording means and the deciding means may be provided in the PoC server.

Alternatively, the recording means may be provided in at least one of said PoC clients and the deciding means may be provided in said PoC server. In this case, the PoC server may comprise determining means for determining, on the basis of the decision result of said deciding means, whether or not to make the PoC client, in which said recording means is provided, join a session. The PoC server may comprise determining means for determining, on the basis of the decision result of said deciding means, whether or not to distribute communication content to the PoC client in which said recording means is provided.

Both of the recording means and the deciding means may be provided in at least one of said PoC clients. In this case, the PoC server may comprise means which, for sessions regarding which there is a possibility of recording communication content, makes the PoC client, in which said recording means is provided, join the session.

It is thereby possible to reduce further the processing load in the PoC server, because the PoC client can decide whether recording of communication content is necessary or not, and on the basis of this decision result the PoC client can record communication content.

The deciding means may comprise means for holding a decision rule to be used as a basis for decisions.

For example, the aforesaid means for holding can comprise means for holding the identifier of a session which is a candidate for recording communication content; and the aforesaid means for deciding can comprise means for deciding, in respect of a communication having the session identifier in question, that recording of its content is necessary. It is thereby possible to decide on a per-session basis whether recording of communication content is necessary or not, and to record communication content.

For example, the aforesaid means for holding can comprise means for holding a group identifier which identifies communication content which should be recorded; and the aforesaid means for deciding can comprise means for deciding, in respect of a communication by a caller having the group identifier in question, that recording of its content is necessary. It is thereby possible to decide whether recording of communication content of a caller is necessary or not on a per-group basis, and to record communication content.

For example, the aforesaid means for holding can comprise means for holding a combination of a session identifier and a caller identifier which identifies communication content which should be recorded; and the aforesaid means for deciding can comprise means for deciding, in respect of a communication where a caller having the caller identifier in question is participating in a communication having the session identifier in question, that recording of its content is necessary. It is thereby possible for recording of communication content to be restricted to cases where a specific caller is participating in a specific session.

For example, the aforesaid means for holding can comprise means for holding a caller identifier which identifies communication content which should be recorded; and the aforesaid means for deciding can comprise means for deciding, in respect of a communication by a caller having the caller identifier in question, that recording of its content is necessary. It is thereby possible to decide whether recording of communication content is necessary or not on a per-caller basis, and to record communication content.

For example, the aforesaid means for holding can comprise means for holding a session identifier which identifies communication content which should be recorded and a list of participants in the session in question; and the aforesaid means for deciding can comprise means for deciding, in respect of a communication where a participant in the participant list in question is not participating in a communication having the session identifier in question, that recording of its content is necessary. It is thereby possible to record communication content when there is a non-participant in a specific session. A non-participant in a session can therefore confirm the communication content afterwards.

For example, the aforesaid means for holding can comprise means for holding a list in which control commands and their instruction contents have been recorded; and the aforesaid means for deciding can comprise means which, when a control command issued by a caller instructs recording of communication content, decides that recording of the communication content in question is necessary, and which, when a control command issued by a caller prohibits recording of communication content, decides that recording of the communication content in question is not necessary. It is thereby possible to record communication content desired by a caller by the use of a control command by that caller.

For example, the aforesaid means for holding can comprise means for holding a threshold for the number of repetitions of identical communication content; and the aforesaid means for deciding can comprise means which, when the number of repetitions of identical communication content exceeds the aforesaid threshold, decides that recording of that communication content is not necessary. It is thereby possible to perform control in respect of communication content which is thought to be “mischievous” and aimed at swamping the recording medium, so that such communication content is not recorded.

The aforesaid recording means or the aforesaid means for recording can comprise means for replacing a predetermined word or sentence with a prescribed word or sentence. This means for replacing can comprise means for holding a rewritable replacement rule.

It is thereby possible to provide a service whereby, if a communication has been carried out using a word current among some users only, this word is replaced with a word that can be understood by the general user. It is also possible to convert words whose use is prohibited with usable words, and/or to mask prohibited words with a “beep” sound.

The aforesaid recording means or the aforesaid means for recording can also comprise means which, for sessions regarding which there is a possibility of recording communication content, records communication content together with floor control information and information containing a caller identifier or time series information, these latter items being among information items acquired from meta-information accompanying the communication content.

It is thereby possible to easily retrieve desired communication content after communication has finished, if the communication content is to be re-confirmed.

According to a second aspect, the present invention is a PoC server applicable to the PoC system of the invention and characterised in that it comprises the aforesaid recording means and the aforesaid means for deciding whether recording of communication content is necessary or not. Alternatively, it is a PoC server applicable to the PoC system of the present invention and characterised in that it comprises the aforesaid means for deciding whether recording of communication content is necessary or not, or the aforesaid means for determining whether or not to make a PoC client join a session, or the aforesaid means for determining whether or not to distribute communication content, or the aforesaid means for making a PoC client join a session.

According to a third aspect, the present invention is a PoC client applicable to the PoC system of the present invention and characterised in that it comprises the aforesaid recording means alone, or alternatively, the aforesaid means for deciding whether recording of communication content is necessary or not, and the aforesaid means for recording communication content.

According to a fourth aspect, the present invention is a program which, by being installed in an information processing device, implements in this information processing device functions corresponding to a PoC server applicable to the PoC system of the present invention and comprising the aforesaid recording means and the aforesaid means for deciding whether recording of communication content is necessary or not. Alternatively, it is a program which, by being installed in an information processing device, implements in this information processing device functions corresponding to a PoC server applicable to the PoC system of the present invention and comprising the aforesaid means for deciding whether recording of communication content is necessary or not, or the aforesaid means for determining whether or not to make a PoC client join a session, or the aforesaid means for determining whether or not to distribute communication content, or the aforesaid means for making a PoC client join a session. Alternatively, it is a program which, by being installed in an information processing device, implements in this information processing device functions corresponding to a PoC client applicable to the PoC system of the present invention and comprising recording means alone, or comprising the aforesaid means for deciding whether recording of communication content is necessary or not, and the aforesaid means for recording communication content.

The program of the present invention can be installed in the aforesaid information processing device by being recorded on a recording medium and using this recording medium for the installation of the program. Alternatively, it is possible to install the program of the present invention directly in the aforesaid information processing device via a network, from a server which holds the program.

It is thereby possible to use a general-purpose information processing device to implement a PoC system which has the following capabilities: 1) it enables communication content to be confirmed afterwards; 2) by recording communication content in conjunction with information such as a caller identifier, it makes it easy to retrieve communication content afterwards; 3) it can record communication content only when this is necessary; 4) it can change as desired the criterion for deciding whether or not to record communication content; 5) rather than simply logging, it can determine, for each speech episode, whether recording is necessary or not, and can therefore perform recording even during communications that include off-record content which it is not desired to leave on record.

The present invention provides the following advantages:
(1) PoC communication content can be confirmed afterwards.
(2) PoC communication content can be easily retrieved afterwards as a result of being recorded in conjunction with information such as a caller identifier.
(3) PoC communication content can be recorded only when necessary.
(4) The criterion for deciding whether or not to record PoC communication content can be changed as desired.
(5) Rather than simply logging, the system of the invention can determine, for each speech episode, whether recording is necessary or not, and can therefore perform recording even during communications that include off-record content which it is not desired to leave on record.

### BRIEF DESCRIPTION OF THE DRAWINGS

Specific embodiments of the present invention will now be described, by way of example only, with reference to the accompanying drawings in which:

FIG. 1 shows the overall configuration of a PoC system according to a first embodiment;

FIG. 2 is a flowchart showing the operation of the PoC server of the first embodiment;

FIG. 3 is a sequence diagram serving to explain a concrete example of the first embodiment;

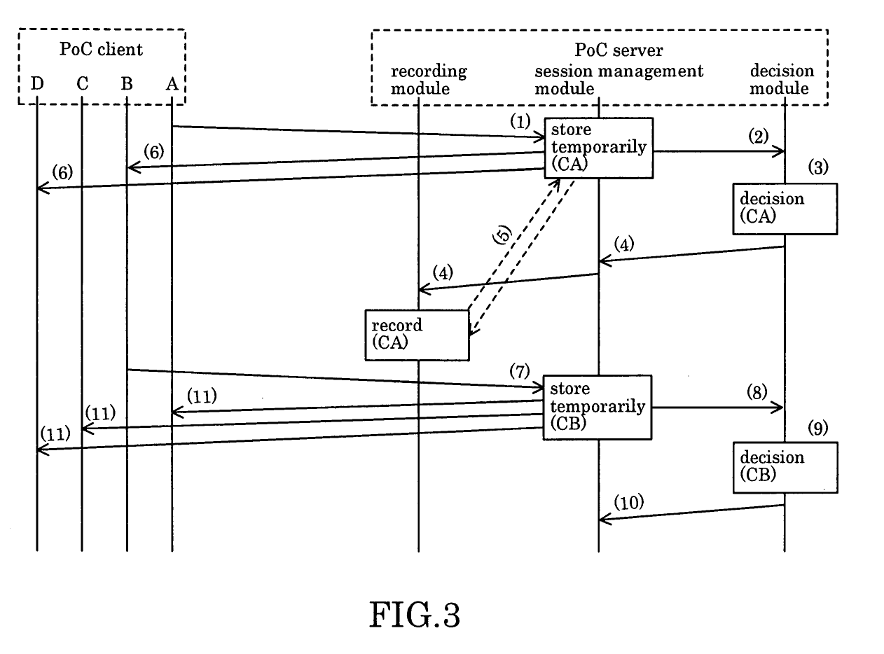

FIG. 4 shows the overall configuration of a PoC system according to a second embodiment;

FIG. 5 shows the overall configuration of a PoC system according to a third embodiment;

FIG. 6 shows the overall configuration of a PoC system according to a fourth and a fifth embodiment;

FIG. 7 is a flowchart showing the operation of the PoC server of the fourth embodiment;

FIG. 8 is a flowchart showing the operation of the PoC client of the fourth embodiment; and

FIG. 9 is a flowchart showing the operation of the PoC server of the fifth embodiment.

### DETAILED DESCRIPTION OF THE PREFERRED EMBODIMENTS

### First Embodiment

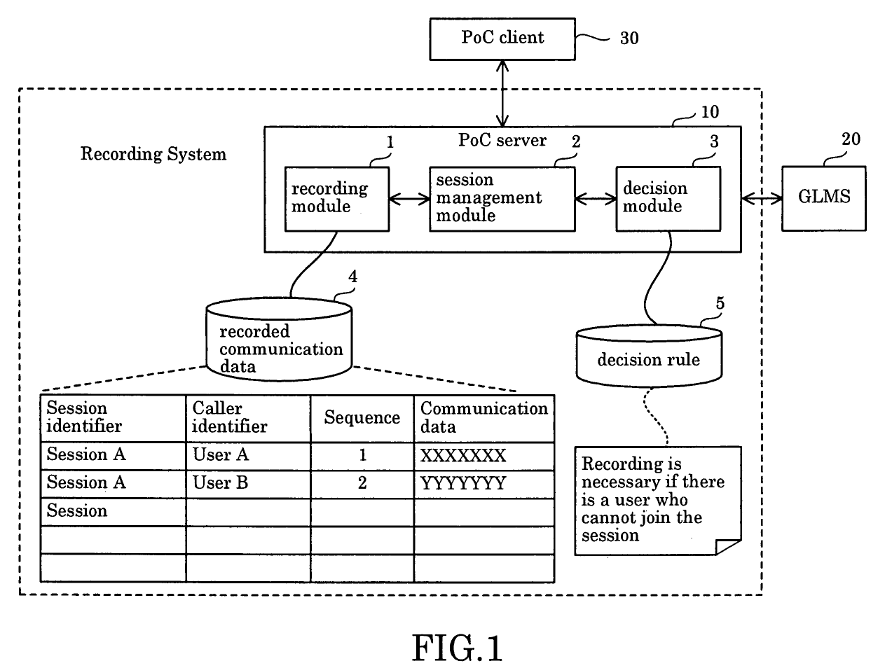

The configuration of a PoC system according to a first embodiment of the present invention will be described with reference to FIG. 1, which illustrates the overall configuration of this PoC system.

To implement a recording service in PoC group communications, the PoC system of the first embodiment provides recording module 1 in PoC server 10 as shown in FIG. 1. In addition to conventional PoC server functions such as session management and floor control, PoC server 10 has decision module 3 for deciding whether recording is necessary or not, and recording module 1. Note that in FIG. 1, most of the fundamental functions of PoC server 10 are omitted and only those session management functions relating to the present invention are shown, as session management module 2. In addition to conventional session management functions, session management module 2 calls decision module 3 and sends recording requests to recording module 1.

Decision module 3 decides, on the basis of decision rule 5 which it holds, whether it is necessary or not to record session communication content. Decision rule 5 is a conditional expression, such as “Record if there is a user who cannot join the session” or “Record sessions of group X”, for the purpose of deciding whether recording of session communication content is necessary or not. If on the basis of decision rule 5 it is decided that recording is necessary, decision module 3 requests, via session management module 2, recording module 1 to record communication content.

When recording module 1 receives a request from session management module 2 to record communication content, it records the communication content together with a session identifier and a caller identifier, as recorded communication data 4. Content recorded by recording module 1 can be acquired by using a session identifier and/or a caller identifier as a retrieval key. Note that although FIG. 1 shows an example of holding the various items of information in a relational database, the data format is not restricted to this.

The first embodiment outlined above is a PoC system comprising PoC server 10 and GLMS 20, whereof the distinguishing feature is that PoC server 10 comprises communication content recording module 1. PoC server 10 also comprises decision module 3 for deciding whether recording of communication content is necessary or not. Recording module 1 comprises means which, for sessions regarding which there is a possibility of recording communication content, records communication content together with floor control information and information containing a caller identifier or time series information, these latter items being among information items acquired from meta-information accompanying the communication content.

Decision module 3 comprises means for holding decision rule 5 which is used as the decision criterion. Decision module 3 comprises for example means for holding a session identifier which identifies communication content which should be recorded, and means for deciding, in respect of a communication having the session identifier in question, that recording of its content is necessary.

Alternatively, decision module 3 comprises means for holding a group identifier which identifies communication content which should be recorded, and means for deciding, in respect of a communication by a caller having the group identifier in question, that recording of its content is necessary.

Alternatively, decision module 3 comprises means for holding a combination of a session identifier and a caller identifier which identifies communication content which should be recorded, and means for deciding, in respect of a communication where a caller having the caller identifier in question is participating in a communication having the session identifier in question, that recording of its content is necessary.

Alternatively, decision module 3 comprises means for holding a caller identifier which identifies communication content which should be recorded, and means for deciding, in respect of a communication by a caller having the caller identifier in question, that recording of its content is necessary.

Alternatively, decision module 3 comprises means for holding a session identifier which identifies communication content which should be recorded and a list of participants in the session in question; and means for deciding, in respect of a communication where a participant in the participant list in question is not participating in a communication having the session identifier in question, that recording of its content is necessary.

Alternatively, decision module 3 comprises means for holding a list in which control commands and their instruction contents have been recorded; and means for deciding which, when a control command issued by a caller instructs recording of communication content, decides that recording of the communication content in question is necessary, and which, when a control command issued by a caller forbids recording of communication content, decides that recording of the communication content in question is not necessary.

Alternatively, decision module 3 comprises means for holding a threshold for the number of repetitions of identical communication content; and means which, if the number of repetitions of identical communication content exceeds the aforesaid threshold, decides that recording of that communication content is not necessary.

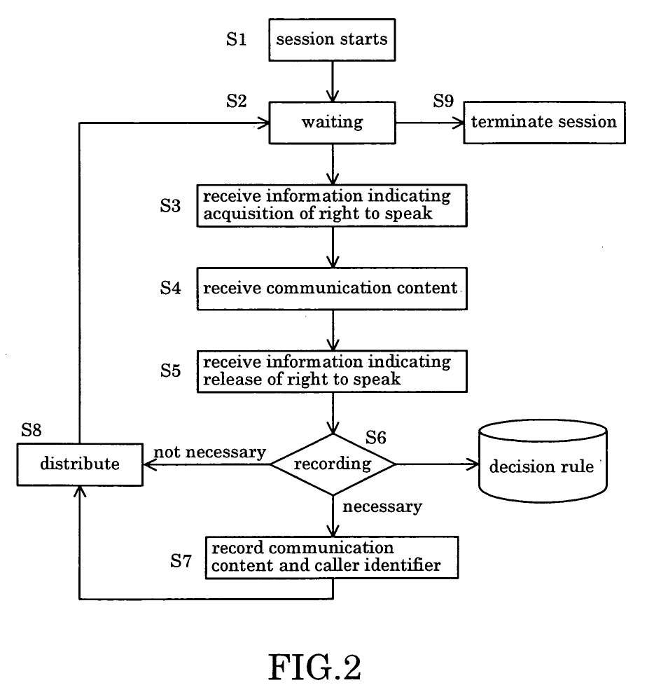

Next, the operation of this first embodiment will be described with reference to FIG. 2, which is a flowchart showing the operation of PoC server 10 of the first embodiment.

A session is started among a plurality of callers (S1). Firstly, a caller who wishes to speak performs a procedure for acquiring the right to speak. While this is happening, communication enters a waiting state (S2). Eventually, the caller wishing to speak acquires the right to speak. Session management module 2 receives information indicating this acquisition of the right to speak (S3). Session management module 2 also receives the communication content (S4). This communication content is temporarily stored in a buffer. When the caller finishes speaking, this caller releases the right to speak. Session management module 2 receives information indicating this release of the right to speak (S5).

Session management module 2 requests decision module 3 to decide whether the received communication content should be recorded or not (S6). On the basis of decision rule 5 which it holds, decision module 3 decides whether recording is necessary or not and returns the decision result to session management module 2. If session management module 2 receives a decision result from decision module 3 to the effect that recording of the communication content is necessary, it requests recording module 1 to record the communication content.

When recording module 1 receives the request from session management module 2, it records the communication content that has been temporarily stored in the buffer, together with the session identifier and the caller identifier (S7). Session management module 2 distributes the communication content to session participants (S8).

The waiting state (S2) is re-established, and steps S3 to S8 are repeated if there is a caller who wishes to speak next. If there is no caller who wishes to speak next, the session is terminated (S9).

Note that for the sake of convenience, in FIG. 2 the processing steps are written out consecutively. However, if recording is necessary, it would also be feasible for recording (step S7) and distribution (step S8) to be processed in parallel, or for order in which step S7 and step S8 are processed to be reversed.

Decision rule 5 is a conditional expression for deciding whether or not recording of session communication content is necessary. Note that, depending on decision rule 5, it is also possible to record only specific communication content of the session. Concrete examples of decision rule 5 are given below, but the decision rule is not restricted to these.
(1) “Record if there is a user who cannot join the session.” In this case, recording is enabled if, based on PoC session management information, there is among the invited users a user who is not participating in the session. If joining and/or leaving an ongoing session is permitted, it is also possible for only a portion of the communication content to be recorded in the PoC server.

To implement example (1) of decision rule 5, decision module 3 comprises means for holding a session identifier which identifies communication content which should be recorded and a list of participants in the session in question; and means for deciding, in respect of a communication where a participant in the participant list in question is not participating in a communication having the session identifier in question, that recording of its content is necessary.
(2) “Record sessions of a specific group X.” In this case, the content of communication that has started within a specific group is recorded, based on the group identifier utilized in the PoC communication. Here, the criterion is who has been invited, regardless of the actual participating members.

To implement example (2) of decision rule 5, decision module 3 comprises means for holding a group identifier which identifies communication content which should be recorded, and means for deciding, in respect of a communication by a caller having the group identifier in question, that recording of its content is necessary.
(3) “Record if user X, user Y and user Z are participating in the session.” In this case the criterion is which members are actually participating in the session, regardless of the group for which the session was started (i.e., regardless of who was invited). As in example (1), application of this rule is based on session participant information which is managed by session management module 2.

To implement example (3) of decision rule 5, decision module 3 comprises means for holding a combination of a session identifier and a caller identifier which identifies communication content which should be recorded, and means for deciding, in respect of a communication where a caller having the caller identifier in question is participating in a communication having the session identifier in question, that recording of its content is necessary.
(4) “Record only communications from user X and user Y.” In this case, the identifier of the caller is acquired on the basis of PoC floor control information, and recording is enabled only for specific callers.

To implement example (4) of decision rule five, decision module 3 comprises means for holding a caller identifier which identifies communication content which should be recorded, and means for deciding, in respect of a communication by a caller having the caller identifier in question, that recording of its content is necessary.
(5) “When group communication starts, record only if recording has been enabled.” In this case, recording is enabled when there has been a session start request accompanied by a control command which enables recording.
(6) “Record only if a caller has sent a control command containing a recording request.” In this case, recording is enabled when a control command enabling recording is contained in a floor request or in the communication content.
(7) “If session communication content is being recorded, do not record if a caller sends a control command forbidding recording (i.e., a control command indicating that the communication content is off-record).” In this case, recording is disabled if a control command forbidding recording is included in a floor request or in communication content.

To implement examples (5), (6) and (7) of decision rule 5, decision module 3 comprises means for holding a list in which control commands and their instruction contents have been recorded; and means for deciding which, when a control command issued by a caller instructs recording of communication content, decides that recording of the communication content in question is necessary, and which, when a control command issued by a caller forbids recording of communication content, decides that recording of the communication content in question is not necessary.
(8) “Do not record communication content which is thought to be mischievous and aimed at swamping the recording medium (such as a disk).” For example, recording in progress is halted if a communication having identical content is repeated.

To implement example (8) of decision rule 5, decision module 3 comprises means for holding a threshold for the number of repetitions of identical communication content; and means for deciding which, when the number of repetitions of identical communication content exceeds the aforesaid threshold, decides that recording of that communication content is not necessary.

Note that the control commands mentioned above can be generated in various ways, including pushing a button on the terminal or voicing some spoken content. Assuming that control commands are generated from spoken content, if a caller says “This is off-record” at the start of a communication, then only the speech in that “burst” is not recorded. A recording can be cancelled by sending a command indicating “off-record” either during or at the end of a communication. It is thereby possible to ensure that no record is left of an utterance that has been mistakenly voiced.

The scope of a control command is not necessarily restricted to a particular utterance, but can continue after the control command has been issued and can extend to all utterances. In this case, the control command remains effective until another control command is issued. Note also that content communicated by PoC server 10 is not restricted to voice but can also be data in any format.

Next, a concrete example of the operations involved in communication among group GA comprising users A, B, C and D will be described with reference to FIG, which is a sequence diagram serving to clarify the example. It is assumed that decision rule 5 has been set as “Record if there is a non-participating user.” It is also assumed that group communication (i.e., a session) began when user A began a communication with the members of group GA, at which point user C was out-of-range and therefore unable to join the session. This session is assumed to be identified in the session management module as session SA.
(1) Session management module 2 receives, from user A, communication content CA for session SA. This communication content CA is temporarily stored in a buffer.
(2) Session management module 2 requests decision module 3 to decide whether or not the communication from user A for session SA should be recorded. At this juncture, other information is also passed from session management module 2 to decision module 3, such as information indicative of the users who have been invited to session SA (user A, user B, user C and user D), and information indicative of the current participants (user A, user B and user D).
(3) Because decision rule 5 held by decision module 3 is “Record if there is a non-participant”, decision module 3 ascertains whether or not there is a non-participant in session SA. Because user C is a non-participant in session SA, decision module 3 returns, to session management module 2, the decision result that recording is necessary.
(4) Session management module 2 receives from decision module 3 the decision result that recording of the communication content is necessary, and requests recording module 1 to record the communication content for session SA from user A.
(5) When recording module 1 receives the request from session management module 2, it records communication content CA that is temporarily stored in the buffer, together with the session identifier (session SA) and the caller identifier (user A).
(6) Session management module 2 distributes the communication content CA to user B and user D who are participating members in the session. It is assumed that user C joins the group in the course of the session and is then a participant in the session.
(7) Session management module 2 receives, from user B, communication content CB for session SA. This communication content CB is temporarily stored in the buffer.
(8) Session management module 2 requests decision module 3 to decide whether or not the communication from user B for session SA should be recorded. At this juncture, other information is also passed from session management module 2 to decision module 3, such as information indicative of the users who have been invited to session SA (user A, user B, user C and user D), and information indicative of the current participants (user A, user B, user C and user D).
(9) Because decision rule 5 held by decision module 3 is “Record if there is a non-participant”, decision module 3 ascertains whether or not there is a non-participant in session SA. Because there is no non-participating user in session SA, decision module 3 returns, to session management module 2, the decision result that recording is unnecessary.
(10) Session management module 2 receives from decision module 3 the decision result that recording of the communication content is unnecessary.
(11) Session management module 2 distributes communication content CB to user A, user C and user D, who are participating members in the session, and no recording of communication content CB is carried out.

### Second Embodiment

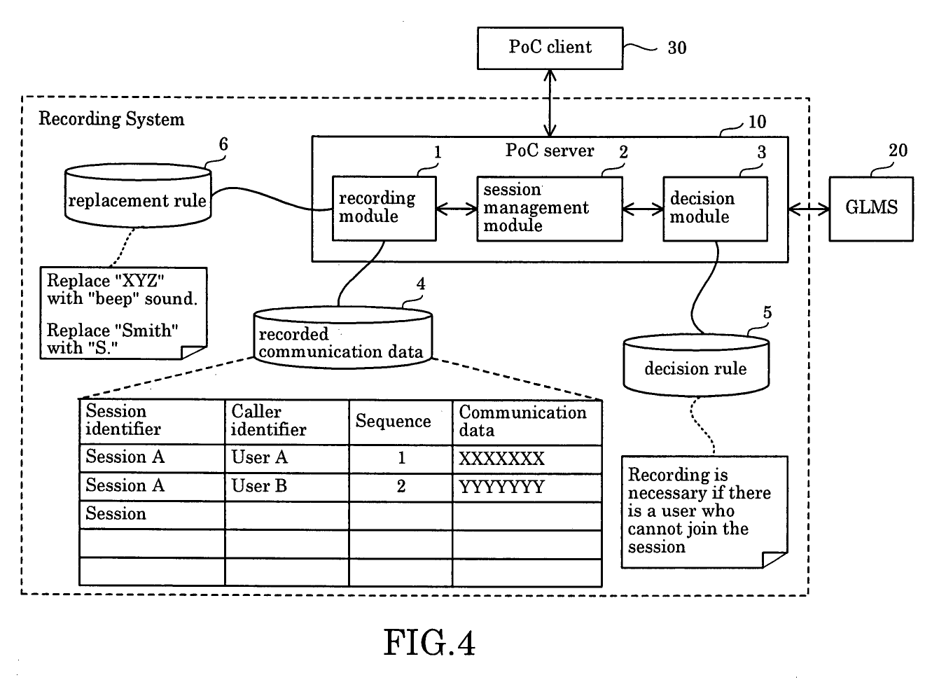

A second embodiment of the PoC system of the present invention will be described with reference to FIG. 4, which illustrates the overall configuration of this PoC system. In the second embodiment, recording module 1 comprises means for replacing predetermined words or sentences with specific words or sentences. This means for replacing comprises means for holding a rewritable replacement rule 6.

That is to say, in the second embodiment, in addition to decision module 3 deciding whether recording is necessary or not, recording module 1 can replace communication content. The replacement process is carried out on the basis of replacement rule 6 held by recording module 1. For example, if a word is uttered that matches a particular registered keyword, such as a word which it is forbidden to broadcast, then instead of being recorded, this word can be replaced with for example a predetermined word pattern. Or if a word which matches a specific keyword is uttered, then instead of recording this word, it can be masked with a “beep” sound. Processing whereby the name of a person is replaced with an initial is also possible.

### Third Embodiment

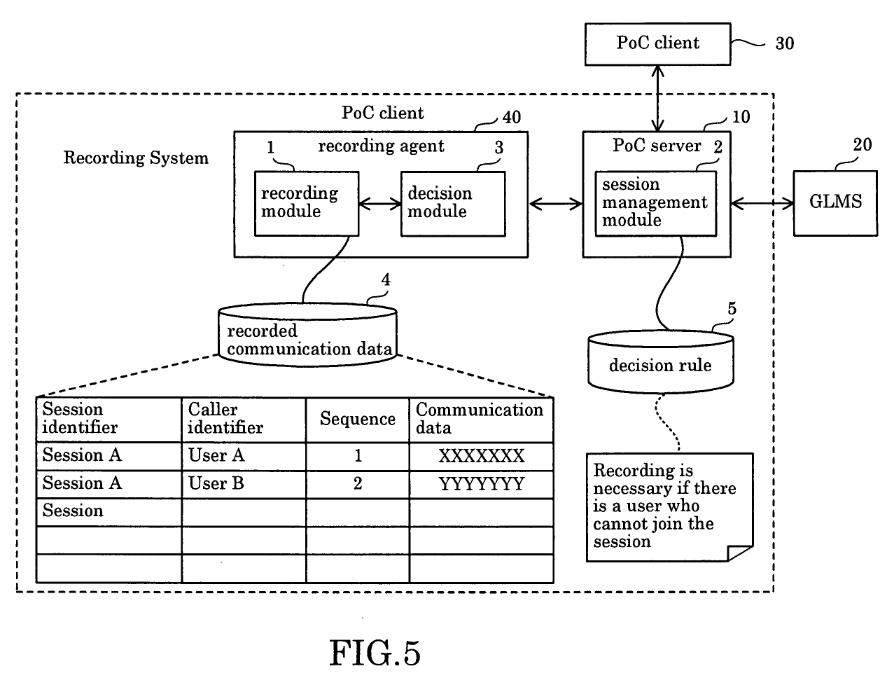

A third embodiment of the PoC system of the present invention will be described with reference to FIG. 5, which illustrates the overall configuration of this PoC system. As shown in FIG. 5, the PoC system of the third embodiment comprises PoC server 10, GLMS 20, and PoC clients 30 and 40 connectable to PoC server 10. A distinguishing feature of this third embodiment is that PoC client 40 serves as a recording agent and comprises decision module 3 for deciding whether recording of communication content is necessary or not, and recording module 1 for recording, on the basis of the decision result of decision module 3, communication content which PoC client 40 itself has received. Session management module 2 of PoC server 10 comprises means which, for sessions regarding which there is a possibility of recording communication content, makes PoC client 40 join a session.

That is to say, in the third embodiment a recording agent, namely PoC client 40 comprising decision module 3 and recording module 1, performs some of the processing steps in the first embodiment. When a session is set up, session management module 2 of PoC server 10 adds the recording agent to the session as a participating member. According to the decision of decision module 3, the recording agent records the received communication content.

### Fourth Embodiment

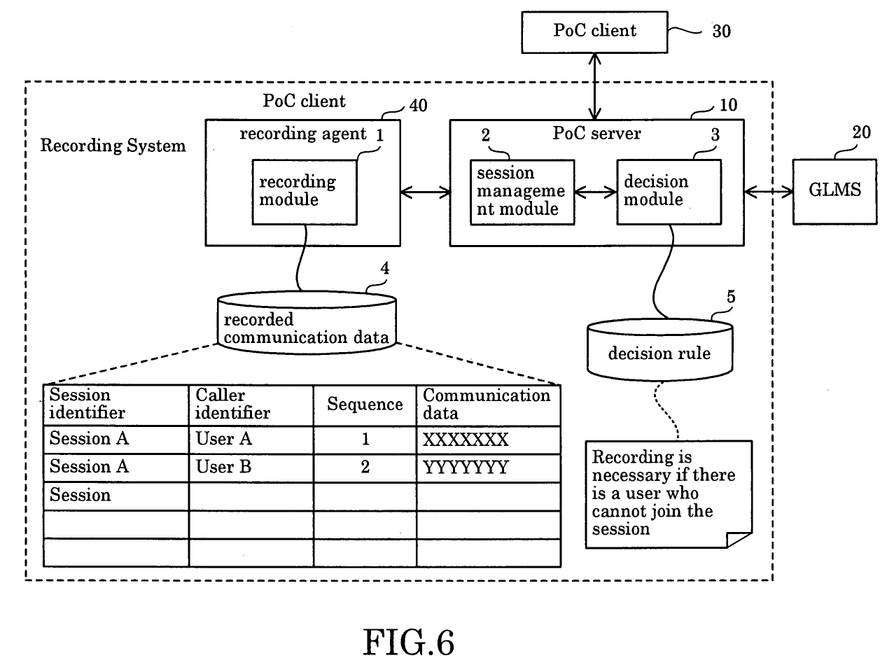

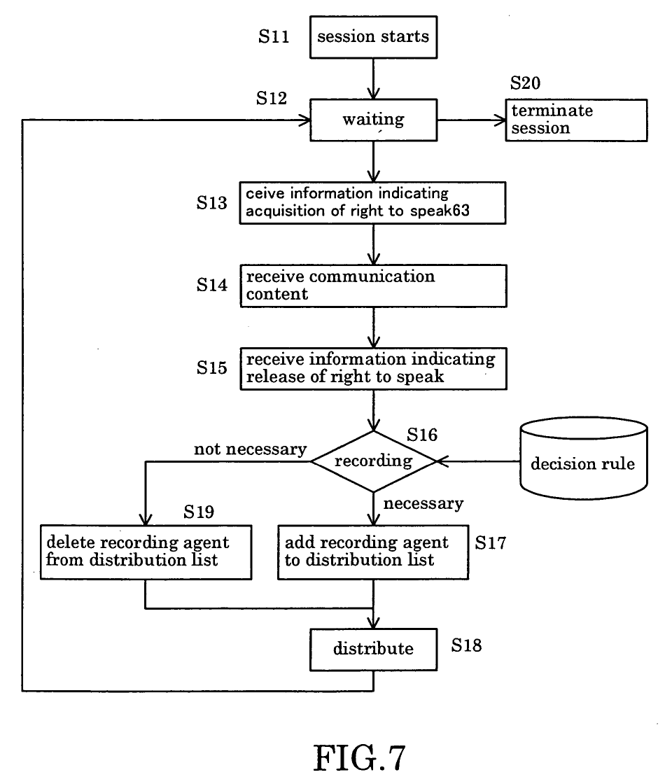

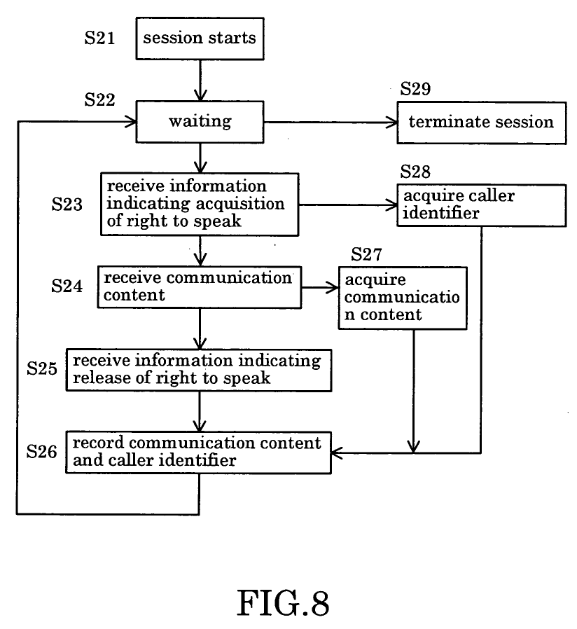

A fourth embodiment of the PoC system of the present invention will be described with reference to FIGS. 6 to 8. FIG. 6 illustrates the overall configuration of this PoC system. FIG. 7 is a flowchart showing the operation of the PoC server, and FIG. 8 is a flowchart showing the operation of the recording agent.

As shown in FIG. 6, this fourth embodiment is a PoC system comprising PoC server 10, GLMS 20, and PoC clients 30 and 40 connectable to PoC server 10. A distinguishing feature of this fourth embodiment is that PoC client 40 serves as a recording agent and comprises communication content recording module 1.

PoC server 10 comprises decision module 3 for deciding whether recording of communication content is necessary or not. PoC server 10 also comprises, in session management module 2, means for determining, on the basis of the decision result of decision module 3, whether or not to distribute communication content to PoC client 40 in its capacity as a recording agent.

That is to say, the fourth embodiment is a system which provides decision module 3 within PoC server 10, and which provides recording module 1 alone within PoC client 40 which is the recording agent. In similar manner to the third embodiment, when a session is set up, PoC server 10 adds the recording agent to the session as a participating member. When session management module 2 receives communication content, it asks decision module 3 for its decision regarding whether or not recording is necessary, and, only when recording is necessary, distributes the communication content to PoC client 40 in its capacity as the recording agent. The recording agent then records all the received content.

The operation of the system of the fourth embodiment will be described with reference to FIG. 7 and FIG. 8. FIG. 7 shows the operation of PoC server 10. A session is started among a plurality of callers (S11). Firstly, a caller who wishes to speak performs a procedure for acquiring the right to speak. While this is happening, communication enters a waiting state (S12). Eventually, the caller wishing to speak acquires the right to speak. Session management module 2 receives information indicating this acquisition of the right to speak (S13). Session management module 2 also receives the communication content (S14). This communication content is temporarily stored in a buffer. When the caller finishes speaking, this caller releases the right to speak. Session management module 2 receives information indicating this release of the right to speak (S15).

Session management module 2 requests decision module 3 to decide whether the received communication content should be recorded or not (S16). On the basis of decision rule 5 which it holds, decision module 3 decides whether recording is necessary or not and returns the decision result to session management module 2. If session management module 2 receives a decision result from decision module 3 to the effect that recording of the communication content is necessary, it adds PoC client 40, which is the recording agent, to the distribution list (S17) and distributes the communication content (S18). If session management module 2 receives a decision result from decision module 3 to the effect that recording of the communication content is unnecessary, it deletes PoC client 40, which is the recording agent, from the distribution list (S19) and distributes the communication content (S18).

The waiting state (S12) is re-established, and steps S13 to S19 are repeated if there is a caller who wishes to speak next. If there is no caller who wishes to speak next, the session is terminated (S20).

FIG. 8 shows the operation of PoC client 40 which is the recording agent. In particular, FIG. 8 shows the operation of PoC client 40 when PoC server 10 has added the recording agent to the distribution list (see S17 in the flowchart shown in FIG. 7). A session is started among a plurality of callers (S21). Firstly, a caller who wishes to speak performs a procedure for acquiring the right to speak. While this is happening, communication enters a waiting state (S22). Eventually, the caller wishing to speak acquires the right to speak. PoC client 40 receives information indicating this acquisition of the right to speak (S23). Recording module 1 then acquires the caller identifier (S28) and PoC client 40 receives the communication content (S24). PoC client 40 then acquires the communication content and temporarily stores it in a buffer (S27). When the caller finishes speaking, this caller releases the right to speak. PoC client 40 receives information indicating this release of the right to speak (S25).

Recording module 1 records the communication content that has been temporarily stored in the buffer, together with the caller identifier (S26).

The waiting state (S22) is re-established, and steps S23 to S28 are repeated if there is a caller who wishes to speak next. If there is no caller who wishes to speak next, the session is terminated (S29).

### Fifth Embodiment

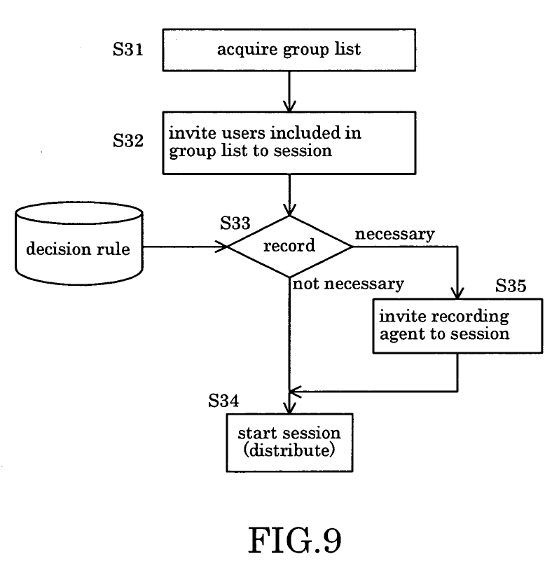

A fifth embodiment will be described with reference to FIG. 6 and FIG. 9. FIG. 6 illustrates the overall configuration of a PoC system according to the fifth embodiment, and is identical to that of the fourth embodiment. FIG. 9 is a flowchart showing the operation of PoC server 10 in the fifth embodiment.

As shown in FIG. 6, the fifth embodiment is a PoC system comprising PoC server 10, GLMS 20, and PoC clients 30 and 40 connectable to PoC server 10. A distinguishing feature of this fifth embodiment is that PoC client 40 in its capacity as a recording agent comprises communication content recording module 1. PoC server 10 comprises decision module 3 for deciding whether recording of communication content is necessary or not. PoC server 10 also comprises, in session management module 2, means for determining, on the basis of the decision result of decision module 3, whether or not to make PoC client 40 join a session, PoC client 40 being the recording agent comprising recording module 1.

The fifth embodiment is a system in which decision module 3 is interrogated only when a session is set up. This system is effective if the result of the decision based on decision rule 5 does not change for each utterance. In this fifth embodiment, when a session is set up, PoC server 10 asks decision module 3 for its decision regarding whether or not recording is necessary. If recording is necessary, it adds PoC client 40, which is the recording agent, to the session as a participating member. When session management module 2 receives communication content, it distributes the communication content to the session members. If recording is necessary, because the recording agent has been included among the session members, the recording agent records all the received content (this is the same as in FIG. 7). If recording is not necessary, because the recording agent is not included among the session members, the communication content is not recorded.

A shown in FIG. 9, session management module 2 acquires a group list from for example PoC client 30 or GLMS 20 (S31), and on this basis invites the users included in the group list to the session (S32). Session management module 2 requests decision module 3 to decide whether session communication should be recorded or not (S33). On the basis of decision rule 5 which it holds, decision module 3 decides whether recording is necessary or not and returns the decision result to session management module 2. If session management module 2 receives a decision result from decision module 3 to the effect that recording of the communication content is necessary, it invites PoC client 40 which is the recording agent to the session (S35). When the session begins (S34), PoC server 10 distributes to the session members, which include the recording agent, the communication content received from any participating member who holds the right to speak.

This fifth embodiment is a system in which addition and deletion of the recording agent to and from a member list is carried out not only when a session is set up, but also when there has been a change in the session membership. This system is effective when communication content is recorded in accordance with whether a member joins a session or not.

### Sixth Embodiment

The present invention can be implemented as a program which, by being installed in a general-purpose information processing device, implements in this information processing device a function corresponding to PoC server 10 or PoC client 40 in the first to the fifth embodiments. This program can be installed in the information processing device after being recorded on a recording medium, or it can be installed in the information processing device via a communication line. It is thereby possible to implement, in the information processing device in question, functions corresponding to PoC server 10 comprising recording module 1, session management module 2 and decision module 3 shown in FIG. 1 or FIG. 4; or to PoC client 40 comprising recording module 1 and decision module 3, and PoC server 10 comprising session management module 2, shown in FIG. 5; or to PoC client 40 comprising recording module 1, and PoC server 10 comprising session management module 2 and decision module 3, shown in FIG. 6.

### Seventh Embodiment

In FIG. 1, FIG. 4, FIG. 5 and FIG. 6, PoC server 10 and GLMS 20 are provided as separate servers, but both PoC server 10 and GLMS 20 can be installed on a single server.

As described above, the present invention can provide a PoC system which has the following capabilities: 1) it enables communication content to be confirmed afterwards; 2) by recording communication content in conjunction with information such as a caller identifier, it makes it easy to retrieve communication content afterwards; 3) it can record communication content only when this is necessary; 4) it can change as desired the criterion for deciding whether or not to record communication content; 5) rather than simply logging, it can determine, for each speech episode, whether recording is necessary or not, and can therefore perform recording even during communications that include off-record content which it is not desired to leave on record.

Because the present invention provides a more convenient PoC system, it can be expected to contribute to user acquisition of PoC systems.

1. A push-to-talk over cellular (PoC) system comprising a PoC server and PoC clients in which said PoC server gives a push-to-talk over cellular service to said PoC clients for making 1-to-N communication, which comprises a recording means for recording communication content.

2. A push-to-talk over cellular system claimed in claim 1, which further comprises a deciding means for deciding whether recording of communication content is necessary or not.

3. A push-to-talk over cellular system claimed in claim 2, wherein both of said recording means and said deciding means are provided in said PoC server.

4. A push-to-talk over cellular system claimed in claim 2, wherein said recording means is provided in at least one of said PoC clients and said deciding means are provided in said PoC server.

5. A push-to-talk over cellular system claimed in claim 4, wherein said PoC server further comprises determining means for determining, on the basis of the decision result of said deciding means, whether or not to make the PoC client, in which said recording means is provided, join a session.

6. A push-to-talk over cellular system claimed in claim 4, wherein said PoC server comprises determining means for determining, on the basis of the decision result of said deciding means, whether or not to distribute communication content to the PoC client in which said recording means is provided.

7. A push-to-talk over cellular system claimed in claim 2, wherein both of said recording means and said deciding means are provided in at least one of said PoC clients.

8. A push-to-talk over cellular system claimed in claim 7, wherein said PoC server comprises means which, for sessions regarding which there is a possibility of recording communication content, makes the PoC client, in which said recording means is provided, join the session.

9. A push-to-talk over cellular system claimed in claim 2, wherein said deciding means comprises holding means for holding a decision rule to be used as a basis for decisions.

10. A push-to-talk over cellular system claimed in claim 9 wherein:
said holding means comprises means for holding a session identifier which identifies communication content which should be recorded; and
said deciding means comprises means for deciding, in respect of a communication having the session identifier in question, that recording of its content is necessary.

11. A push-to-talk over cellular system claimed in claim 9, wherein:
said holding means comprises means for holding a group identifier which identifies communication content which should be recorded; and
said deciding means comprises means for deciding, in respect of a communication by a caller having the group identifier in question, that recording of its content is necessary.

12. A push-to-talk over cellular system claimed in claim 9, wherein:
said holding means comprises means for holding a combination of a session identifier and a caller identifier which identifies communication content which should be recorded; and
said deciding means comprises means for deciding, in respect of a communication where a caller having the caller identifier in question is participating in a communication having the session identifier in question, that recording of its content is necessary.

13. A push-to-talk over cellular system claimed in claim 9, wherein:
said holding means comprises means for holding a caller identifier which identifies communication content which should be recorded; and
said deciding means comprises means for deciding, in respect of a communication by a caller having the caller identifier in question, that recording of its content is necessary.

14. A push-to-talk over cellular system claimed in claim 9, wherein:
said holding means comprises means for holding a session identifier which identifies communication content which should be recorded and a list of participants in the session in question; and
said deciding means comprises means for deciding, in respect of a communication where a participant in the participant list in question is not participating in a communication having the session identifier in question, that recording of its content is necessary.

15. A push-to-talk over cellular system claimed in claim 9, wherein:
said holding means comprises means for holding a list in which control commands and their instruction contents have been recorded; and
said deciding means comprises means which, when a control command issued by a caller instructs recording of communication content, decides that recording of the communication content in question is necessary, and which, when a control command issued by a caller prohibits recording of communication content, decides that recording of the communication content in question is not necessary.

16. A push-to-talk over cellular system claimed in claim 9, wherein:
said holding means comprises means for holding a threshold for the number of repetitions of identical communication content; and
said deciding means comprises means which, if the number of repetitions of identical communication content exceeds said threshold, decides that recording of that communication content is not necessary.

17. A push-to-talk over cellular system claimed in claim 1, wherein said recording means comprises means for replacing a predetermined word or sentence with a prescribed word or sentence.

18. A push-to-talk over cellular system as recited in claim 17, wherein said means for replacing comprises means for holding a rewritable replacement rule.

19. A push-to-talk over cellular system claimed in claim 1, wherein said recording means comprises means which, for sessions regarding which there is a possibility of recording communication content, records said communication content together with floor control information and information containing a caller identifier or time series information, these latter items being among information items acquired from meta-information accompanying the communication content.

20. A push-to-talk over cellular server which gives a push-to-talk over cellular service to PoC clients for making 1-to-N communication, which comprises a recording means for recording communication content.

21. A push-to-talk over cellular server claimed in claim 20 which further comprises a deciding means for deciding whether recording of communication content is necessary or not.

22. A push-to-talk over cellular server which gives a push-to-talk over cellular service to PoC clients for making 1-to-N communication, which comprises a deciding means for deciding whether recording of communication content is necessary or not; and determining means for determining, on the basis of the decision result of said deciding means, whether or not to make a PoC client in which a recording means for recording communication content is provided join a session or whether or not to distribute communication content to the PoC client.

23. A push-to-talk over cellular server which gives a push-to-talk over cellular service to PoC clients for making 1-to-N communication, which comprises means which, for sessions regarding which there is a possibility of recording communication content, makes a PoC client, which comprises a recording means for recording communication content and a deciding means for deciding whether recording of communication content is necessary or not, join the session.

24. A push-to-talk over cellular client which comprising a recording means for recording communication content on a push-to-talk over cellular service.

25. A push-to-talk over cellular client claimed in claim 24, which comprising a deciding means for deciding whether recording of communication content is necessary or not, and said means for recording communication content.

26. A computer program which, by being installed in an information processing device, implements in this information processing device functions corresponding to a push-to-talk over cellular server claimed in any of claims 20-23.

27. A computer program which, by being installed in an information processing device, implements in this information processing device functions corresponding to a push-to-talk over cellular client claimed in claim 24 or 25.
